(19) United States
(12) Patent Application Publication
(10) Pub. No.: US 2026/0265937 A1
(43) Pub. Date: Sep. 10, 2026

(54) POROUS TRANSPORT LAYER FOR ELECTROCHEMICAL CELLS

(71) Applicant: GM Global Technology Operations LLC, Detroit, MI (US)

(72) Inventors: Swaminatha P. Kumaraguru, Rochester Hills, MI (US); Pongsarun Satjaritanun, Pontiac, MI (US)

(21) Appl. No.: 19/073,378

(22) Filed: Mar. 7, 2025

(51) Int. Cl. C25B 13/02; B22F 3/16; B22F 3/24; C25B 9/23; C25B 11/032; C25B 11/056; C25B 11/063; C25B 13/08

(52) U.S. Cl. CPC C25B 13/02; B22F 3/16; B22F 3/24; C25B 9/23; C25B 11/032; C25B 11/056; C25B 11/063; C25B 13/08; B22F 2003/242; B22F 2003/247; B22F 2301/205; B22F 2998/10

(57) ABSTRACT

An electrochemical cell, an electrolyzer, and a process is provided. The electrochemical cell includes a first electrode layer including an anode layer, a second electrode layer including a cathode layer, a polymer electrolyte membrane extending between the first electrode layer and the second electrode layer, a first porous transport layer adjacent to the first electrode layer, a second porous transport layer adjacent to the second electrode layer, a first separator plate disposed adjacent to the first porous transport layer, and a second separator plate disposed adjacent to the second porous transport layer. The first porous transport layer includes a first surface having a planar configuration and a second surface including embossed features. The first surface faces the first electrode layer. The second surface faces a first separator plate, and the second surface is configured to facilitate water transport.

### INTRODUCTION

The present disclosure relates to membrane electrode layer assemblies for fuel cells and electrolyzers, and more particularly to a membrane electrode assembly having proton transport layers.

Electrochemical fuel cells are used as electrical power sources for electric vehicles or other devices. Electrochemical fuel cells, or simply fuel cells, convert reactants in the form of fuel and oxidants into electricity. In one exemplary configuration, a fuel cell includes an anode layer, a cathode layer spaced from the anode layer, and a polymer electrolyte membrane (PEM) separating the anode layer and cathode layer. A hydrogen-rich gas or pure hydrogen is supplied as fuel to the anode layer side of the fuel cell while oxygen is supplied to the cathode layer side. The anode layer and cathode layer form an electric circuit when a current flowing from the anode layer to the cathode layer is routed through a connected external load. The PEM prevents gas crossover and electric current flow but permits proton migration from the anode layer to the cathode layer.

Electrolyzers are devices that utilizes electricity through an electrolysis process to split water molecules into hydrogen and oxygen gases. Electrolyzers are complementary technology to fuel cells. In one exemplary configuration, a PEM electrolyzer includes an electrolytic cell having a cathode layer, an anode layer, and a PEM separating the anode layer and the cathode layer. Electrolysis occurs when electric energy is applied across the electrolytic cell. The anode layer strips the positive charged hydrogen ions (H⁺) from water and releases oxygen gas (O₂). The PEM allows positively charged hydrogen ions (H⁺) to pass from the anode layer to cathode layer. The cathode layer attracts the positively charged hydrogen ions (H⁺) and releases hydrogen gas (H₂). Similarly, an anion exchange membrane (AEM) electrolyzer is another type of water electrolyzer that uses a semipermeable membrane to split water molecule into hydrogen and oxygen gases, where the membrane permits negative charge hydroxide ions (OH⁻) called anion to pass through but blocks positive charged hydrogen ions (H⁺) from cathode layer to anode layer. AEM electrolysis works by using electric energy applied across the electrolytic cell. The anode layer attracts the negative charge hydroxide ions (OH⁻), lose electron, and release oxygen gas (O₂). The cathode layer gain electrons and form hydrogen gas (H₂).

Fuel cells and electrolyzers typically have a membrane electrode assembly (MEA) that includes an ionically conductive polymer membrane disposed between an anode layer and a cathode layer. Protons flow between the anode layer and cathode layer through the ionically conductive polymer membrane. The anode layer and cathode layer are formed of porous conductive materials, such as titanium fiber felt, woven graphite, graphitized sheets, or carbon paper to enable the fuel/water to disperse over the surface of the polymer membrane facing the fuel/water supply electrode layer. One or more of the electrode layers has finely divided catalyst particles, such as platinum group metals (PGM) supported on carbon particles.

While present fuel cells and electrolyzers achieve their intended purpose, there is a need for new and improved fuel cells and electrolyzers that offer improved efficiency and performance.

### SUMMARY

According to several aspects of the present disclosure, an electrochemical cell is provided. The membrane electrode assembly includes a first electrode layer including an anode layer, a second electrode layer including a cathode layer, a polymer electrolyte membrane extending between the first electrode layer and the second electrode layer, a first porous transport layer adjacent to the first electrode layer, a second porous transport layer adjacent to the second electrode layer, a first separator plate disposed adjacent to the first porous transport layer, and a second separator plate disposed adjacent to the second porous transport layer. The first porous transport layer includes a first surface having a planar configuration and a second surface including embossed features. The first surface faces the first electrode layer. The second surface faces a first separator plate, and the second surface is configured to facilitate water transport.

In accordance with another aspect of the disclosure, the embossed features include dimples.

In accordance with another aspect of the disclosure, the embossed features include land channels.

In accordance with another aspect of the disclosure, the first separator plate includes a side with embossed features having a dimple configuration facing the second surface of the first porous transport layer. The embossed features of the second surface include dimples, and the first separator plate and the second surface are disposed in a non-nested configuration that maximizes a water flow pathway.

In accordance with another aspect of the disclosure, the first separator plate includes a side having embossed features including a dimple configuration facing the second surface of the first porous transport layer. The embossed features of the second surface include land channels, and the first separator plate and the second surface are disposed in a non-nested configuration that maximizes a water flow pathway.

In accordance with another aspect of the disclosure, the first porous transport layer is at least one of porous titanium, nickel or stainless steel.

In accordance with another aspect of the disclosure, the first porous transport layer includes a coating of titanium nitride.

In accordance with another aspect of the disclosure, the first porous transport layer includes a coating of at least one of gold or platinum.

According to several aspects of the present disclosure, an electrolyzer having at least one electrochemical cell is provided. The electrolyzer includes a membrane electrode assembly, which further includes a first electrode layer including an anode layer, a second electrode layer including a cathode layer, a polymer electrolyte membrane extending between the first electrode layer and the second electrode layer, a first porous transport layer adjacent to the first electrode layer, a second porous transport layer adjacent to the second electrode layer, a first separator plate disposed adjacent to the first porous transport layer, and a second separator plate disposed adjacent to the second porous transport layer. The first porous transport layer includes a first surface having a planar configuration and a second surface including embossed features. The first surface faces the first electrode layer. The second surface faces a first separator plate, and the second surface is configured to facilitate water transport.

In accordance with another aspect of the disclosure, the embossed features include dimples.

In accordance with another aspect of the disclosure, the embossed features include land channels.

In accordance with another aspect of the disclosure, the first separator plate includes a side with embossed features having a dimple configuration facing the second surface of the first porous transport layer. The embossed features of the second surface include dimples, and the first separator plate and the second surface are disposed in a non-nested configuration that maximizes a water flow pathway.

In accordance with another aspect of the disclosure, the first separator plate includes a side having embossed features having a dimple configuration facing the second surface of the first porous transport layer. The embossed features of the second surface include land channels, and the first separator plate and the second surface are disposed in a non-nested configuration that maximizes a water flow pathway.

In accordance with another aspect of the disclosure, the first porous transport layer is at least one of porous titanium, nickel, or stainless steel.

In accordance with another aspect of the disclosure, the first porous transport layer includes a coating of titanium nitride.

In accordance with another aspect of the disclosure, the first porous transport layer includes a coating of at least one of gold or platinum.

According to several aspects of the present disclosure, a process is provided. The process includes mixing titanium powder with adhesive powder and at least one lubricant to provide brittle titanium particles in a slurry, providing the slurry to a die, compacting the slurry under high pressure with the die to form a green compact, and sintering the green compact to form a titanium felt configured to function as a porous transport layer in a polymer electrolyte membrane electrolysis cell. A first surface of the die is planar and a second surface of the die includes embossing features configured to form embossed features on a porous transport layer.

In accordance with another aspect of the disclosure, the embossing features include at least one of dimples or land channels.

In accordance with another aspect of the disclosure, the process includes cleaning the titanium felt to form a porous transport layer.

In accordance with another aspect of the disclosure, the process includes coating the porous transport layer with at least one of gold or platinum.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a top perspective view illustrating an example of a vehicle having an electric motor powered by a fuel cell with an electrolyzer, in accordance with the present disclosure.

FIG. 2 is a diagrammatic representation illustrating a cross-section of a membrane electrode assembly (MEA) configurable for use in an electrochemical cell and electrolyzer, for example in the vehicle shown in FIG. 1, in accordance with the present disclosure.

FIG. 3 is a perspective view illustrating a first porous transport layer for the electrochemical cell or electrolyzer shown in FIG. 2, where the first porous transport layer has embossed features, in accordance with the present disclosure.

FIG. 4A is a perspective view illustrating a first porous transport layer for the electrochemical cell or electrolyzer shown in FIG. 2, where the first porous transport layer has embossed features, in accordance with the present disclosure.

FIG. 4B is a perspective view illustrating a first porous transport layer disposed between a polymer electrolyte membrane and a first separator plate, where the first porous layer has embossed features in a non-nested configuration, in accordance with the present disclosure.

FIG. 5 is a flowchart illustrating a method for forming the first porous transport layer shown in FIGS. 3 and 4, in accordance with the present disclosure.

FIG. 6 is a perspective view illustrating a die used in the method shown in FIG. 5, in accordance with the present disclosure.

FIG. 7 is a perspective view illustrating a die used in the method shown in FIG. 5, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

An electrochemical cell, an electrolyzer, and a process for forming a porous transport layer (PTL) is disclosed herein. In current polymer electrolyte membrane (PEM) electrolyzers, water flow in the anode compartment is largely managed by flow field patterns in the separator plate. The porous transport layer function is limited to providing support to the MEA along with facilitating water transport to the MEA and removal of oxygen from the MEA. The membrane electrode assembly and electrochemical cell disclosed herein support the water flow in the anode compartment. A first side of the porous transport layer (PTL) facing the anode electrode may be similar to a standard porous transport layer with a planar configuration, and a second side of the porous transport layer (PTL) facing separator plates has embossed features as subsequently described, which mimics separator plate function. The embossed features reduce pressure drop and enhance oxygen transport in the anode compartment as well as reduce the formability requirement of the separator plate.

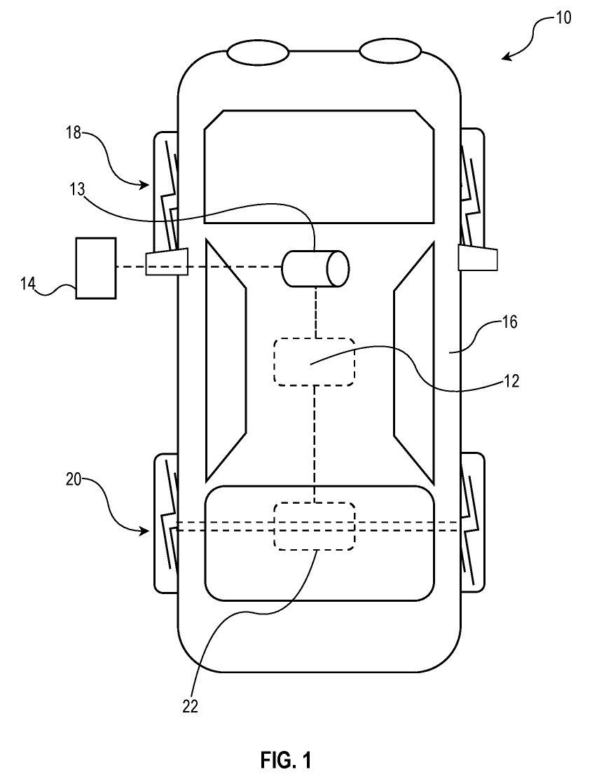

Referring to FIG. 1, a diagrammatic view of a vehicle 10 having an energy conversion device 12 is illustrated, in accordance with the present disclosure. The vehicle 10 generally includes a body 16, which has front wheels 18 and rear wheels 20. The front wheels 18 and the rear wheels 20 are each rotationally located near a respective corner of the body 16. At least one of the front wheels 18 and the rear wheels 20 is propelled by a motor 22 powered directly or indirectly by the energy conversion device 12. Hydrogen for the electrochemical cell to power the vehicle is supplied from a hydrogen storage tank 13. In some embodiments, vehicle 10 receives hydrogen fuel from an external electrolyzer 14 (electrolysis cells) configured to produce hydrogen that can be delivered to the hydrogen fuel storage tank 13 and/or energy conversion device 12.

In one non-limiting embodiment, the motor 22 is an electric motor, and the energy conversion device 12 is a fuel cell configured to convert a hydrogen rich fuel and oxygen from the ambient air into electricity to power the electric motor. While the vehicle 10 is depicted in the illustrated embodiment as a passenger car, other examples of vehicles include, but are not limited to, motorcycles, trucks, sport utility vehicles (SUVs), recreational vehicles (RVs), marine vessels, and aircraft. In certain embodiments, the energy conversion device 12 is a unitized regenerative fuel cell.

As used herein, the term “vehicle” is not limited to automobiles. While the present technology is described primarily herein in connection with electric and/or hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

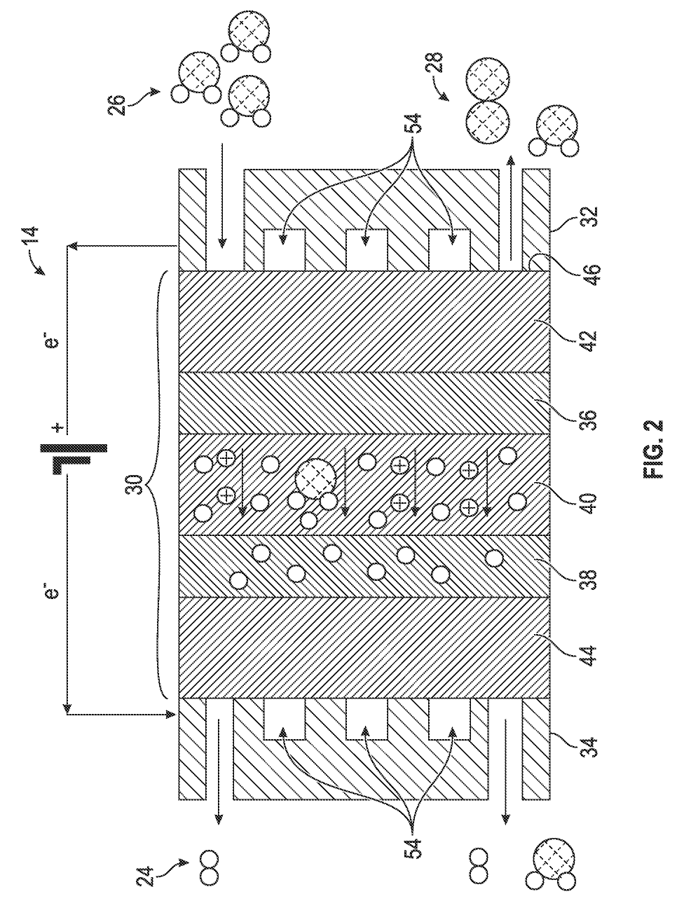

FIG. 2 is a diagrammatic illustration of a non-limiting example of the electrolyzer 14. The electrolyzer 14 produces hydrogen gas (H₂) 24, which may be further used by and/or within a fuel cell, by a process called electrolysis or water splitting. During electrolysis, water (H₂O) 26 is fed into the electrolyzer 14, an electric current is applied, and hydrogen gas (H₂) 24and oxygen gas (O₂) 28 are produced. The hydrogen gas (H₂) 24 may be further used by a fuel cell. The electrolyzer 14 includes a membrane electrode assembly (MEA) 30, a first separator plate 32, and a second separator plate 34.

Still referring to FIG. 2, the MEA 30 includes a first electrode layer 36, a second electrode layer 38, a polymer electrolyte membrane (PEM) 40, a first porous transport layer (PTL) 42, and a second porous transport layer (PTL) 44 or a gas diffusion layer. In the MEA 30, the PEM 40 is sandwiched and extends between the first electrode layer 36 and the second electrode layer 38. In an example, the PEM 40 may include a fluoropolymer (PFSA) proton permeable electrical insulator barrier or a hydrocarbon variant. It will be appreciated that the PEM 40 may include other suitable materials.

The first electrode layer 36 and the second electrode layer 38 are electrically insulated from each other by the PEM 40. The first electrode layer 36 is an anode (or anode layer) and the second electrode layer 38 is a cathode (or cathode layer). The PEM 40 prevents both gas crossover and electric current flow but permits proton migration from the anode layer to the cathode layer. The PEM 40 allows the transport of the protons from the first electrode layer 36 (e.g., anode) to the second electrode layer 38 (e.g., cathode) through the membrane of the PEM 40 but forces electrons to travel around a conductive path to the second electrode layer 38. Additionally, the PEM 40 serves as an insulator for electrons (e⁻) to flow through an external circuit (not shown). The PEM 40 may be comprised of a fluoropolymer proton permeable electrical insulator barrier. Alternatively, the PEM 40 may be comprised of a hydrocarbon proton permeable electrical insulator barrier. Moreover, the PEM 40 may be comprised of a sulfonic acid ionomer. It will be appreciated that the PEM 40 may include other suitable materials.

The first electrode layer 36 and the second electrode layer 38 may be heat pressed onto the PEM 40. At least one of the first electrode layer 36 or the second electrode layer 38 is typically formed from carbon cloth, carbon fiber papers, or a nanoparticle metal catalyst bound together with an ion conducting polymer. In some instances, the ion conducting polymer may be similar to the ion conducting polymer used to form the polymer electrolyte membrane 40. Some non-limiting examples of the nanoparticle platinum group metal (PGM) catalyst may include platinum (Pt) supported on carbon (C), also referred to as a Pt/C catalyst or Pt/C, ruthenium, and/or an iridium oxide (IrOx) catalyst. Referring to the example depicted by FIG. 2, the MEA 30 is shown in a configuration for use in an electrolyzer 14. In the electrolyzer 14 configuration, the first electrode layer 36 is an anode layer and the second electrode layer 38 is a cathode layer.

As shown in FIG. 2, adjacent and/or coupled to the first electrode layer 36 is the first porous transport layer (PTL) 42 that facilitates gas and fluid transport. Similarly, adjacent and/or coupled to the second electrode layer 38 is the second porous transport layer (PTL) 44 that also facilitates gas and fluid transport. The first porous transport layer (PTL) 42 and the second porous transport layer (PTL) 44 may also be referred to as first and second gas diffusion layers (GDL), respectively. The first porous transport layer (PTL) 42 and the second porous transport layer (PTL) 44 may be made of porous, flat sheets of titanium, stainless steel, nickel, and/or nonwoven carbon paper, for example. In some instances, the first porous transport layer (PTL) 42 and/or the second porous transport layer (PTL) 44 may include a coating 46 of gold, titanium nitride, or platinum. When the coating 46 is included, the coating 46 may cover all or only a portion of the first porous transport layer (PTL) 42 and/or the second porous transport layer (PTL) 44. These coatings may be configured to eliminate, minimize, or prevent corrosion. It will be appreciated that the first porous transport layer (PTL) 42 and/or the second porous transport layer (PTL) 44 may include other suitable coatings or may not include any coating.

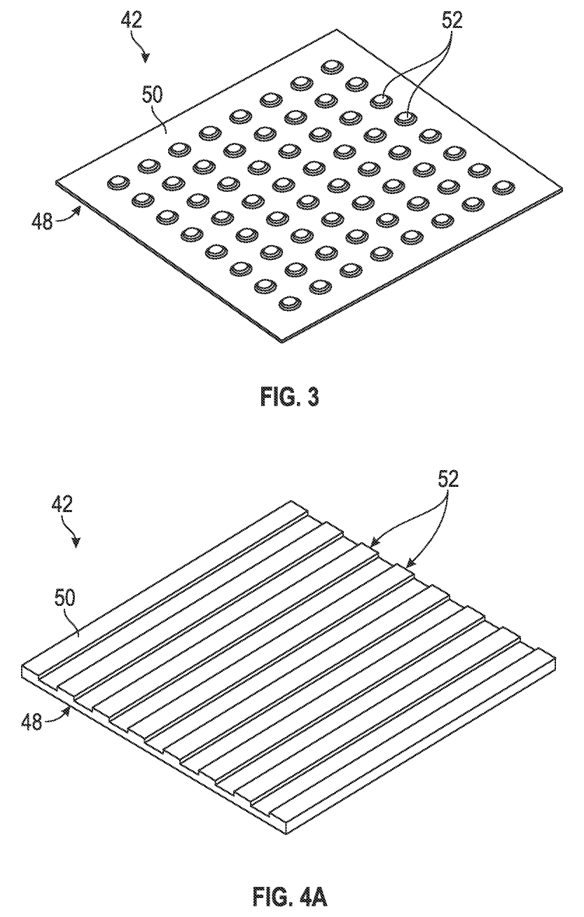

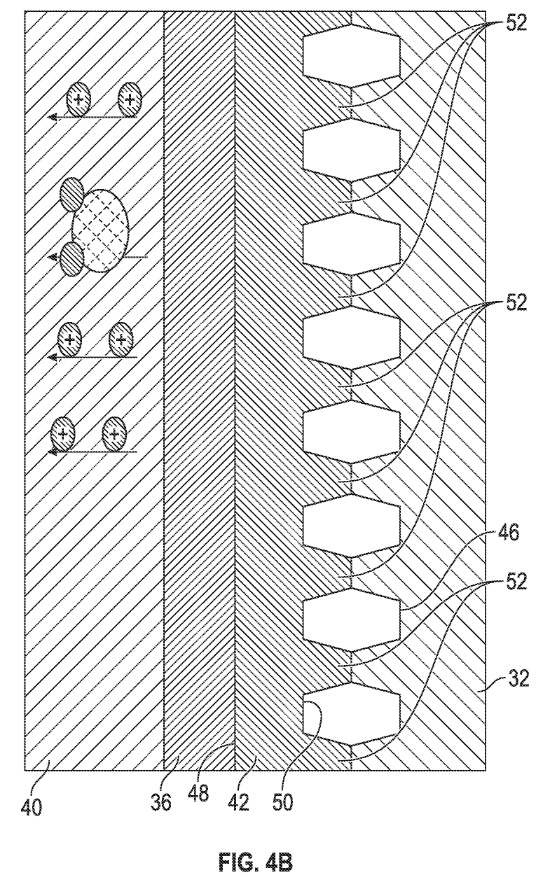

As illustrated in FIGS. 3 and 4, the first porous transport layer (PTL) 42 includes a first surface 48 and a second surface 50. The first surface 48 has a planar configuration, faces, and abuts the first electrode layer 36. The second surface 50 has embossed features 52 and is distal from and faces away from the first electrode layer 36. The second surface 50 is configured to facilitate water transport through and/or to the membrane electrode assembly (MEA) 30.

In the example illustrated in FIG. 3, the embossed features 52 include a plurality of curvilinear protrusions or dimples. Although the dimples are shown in an 8X8 array, the dimples may include other configurations (e.g., a 6X6 array, a 3X9 array, and so forth). The dimples may also be arranged in a predetermined pattern that does not conform to a traditional tow and column arrangement. The embossed features 52 may be various shapes and sizes, and they may be arranged by factors such as spatial constraints and/or functional considerations. For example, the dimples (and/or other embossed features 52) may alternatively be arranged in a staggered configuration, a radial arrangement, a non-array or non-uniform configuration, and/or a random arrangement. In the example illustrated in FIG. 4, the embossed features 52 include a plurality of linear protrusions that form land channels or grooves, where each land channel or groove is configured to carry water 26 from the MEA 30. The embossed features 52 incorporated into the first porous transport layer (PTL) 42 serve to support water distribution, oxygen (O₂) gas removal, and enable a reduction in pressure drop in an anode flow field. Additionally, the embossed features 52 disclosed herein reduce formability requirements of an associated first separator plate 32.

Referring again to FIG. 2, the membrane electrode assembly (MEA) 30 includes the first separator plate 32 (or first flow field plate). The first separator plate 32 is disposed adjacent to and/or coupled to the first porous transport layer (PTL) 42. The first separator plate 32 provides an adequate amount of reactants (hydrogen gas (H₂) 24, oxygen (O₂) gas 28, and/or water 26) to or from the first porous transport layer (PTL) 42, the second porous transport layer (PTL) 44, the first electrode layer 36, and/or the second electrode layer 38 while minimizing pressure drop. The first separator plate 32 may be formed from a single unitary sheet of metal (e.g., titanium). Additionally, the first separator plate 32 and the first porous transport layer (PTL) 42 define a flow field that allows water 26 to flow from an inlet in the first separator plate 32 to the first electrode layer 36. The first separator plate 32 may include at least one channel 54 configured to carry a fluid, for example gas or liquid. In some examples, the first separator plate 32 includes channels 54 that form a serpentine configuration, a parallel configuration, or interdigitated configuration.

In the example shown in FIG. 4B, the first separator plate 32 includes a side with embossed features including a dimple configuration facing the second surface 50 of the first porous transport layer (PTL) 42, wherein the embossed features of the second surface 50 include dimples, and wherein the first separator plate 32 and the second surface 50 are disposed in a non-nested configuration that maximizes a water flow pathway. A person of skill in the art will understand the meaning of non-nested. Alternatively, non-nested may mean a configuration where the flow channels and/or embossed features of the first separator plate 32 are not interlocked or aligned with the embossed features 52 of the first porous transport layer (PTL) 42.

In another specific example, the first separator plate 32 includes a side having embossed features including a dimple configuration facing the second surface 50 of the first porous transport layer (PTL) 42, wherein the embossed features 52 of the second surface 50 include land channels, and wherein the first separator plate 32 and the second surface 50 are disposed in a non-nested configuration that maximizes a water flow pathway.

Referring still to FIG. 2, the membrane electrode assembly (MEA) 30 includes a second separator plate 34 (or second flow field plate). The second separator plate 34 is disposed adjacent to and/or coupled to the second porous transport layer (PTL) 44. The second separator plate 34 provides an adequate amount of reactants (hydrogen (H₂) 24, oxygen(O₂) 28, and/or water 26) to or from the second porous transport layer (PTL) 44, and/or the second electrode layer 38 while minimizing pressure drop. The second separator plate 34 may be formed from a single unitary sheet of metal (e.g., titanium) or other suitable materials. The second separator plate 34 may include at least one channel 54 configured to carry a fluid, for example gas or liquid. In some examples, the second separator plate 34 includes channels 54 that form a serpentine configuration, a parallel configuration, or interdigitated configuration.

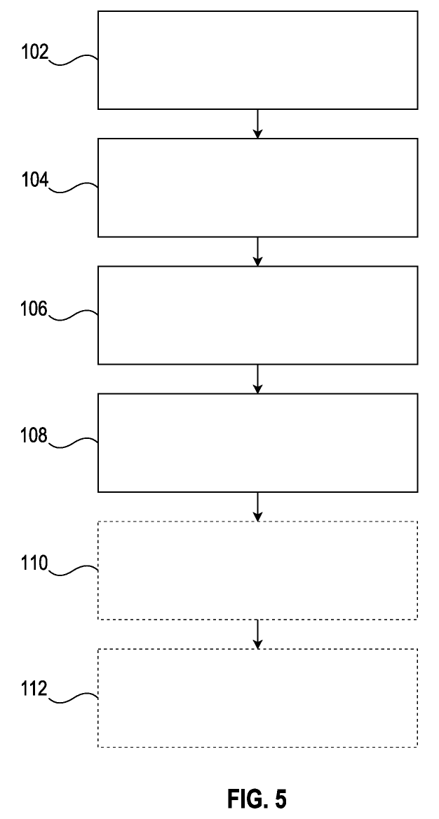

With reference to FIG. 5, a method 100 for forming the first porous transport layer (PTL) 42 shown in FIGS. 2 through 4 is presented, in accordance with the present disclosure. The method 100 starts at block 102.

Block 102 depicts mixing titanium powder with adhesive powder and at least one lubricant to provide brittle titanium particles in a slurry. In an example, a high-purity titanium powder may be prepared, such as through a method like gas atomization, to ensure uniform particle size and shape. The titanium powder can be mixed in a mixer, for example a helical mixer, with the adhesive powder, at least one lubricant, and/or a carrier to form the slurry.

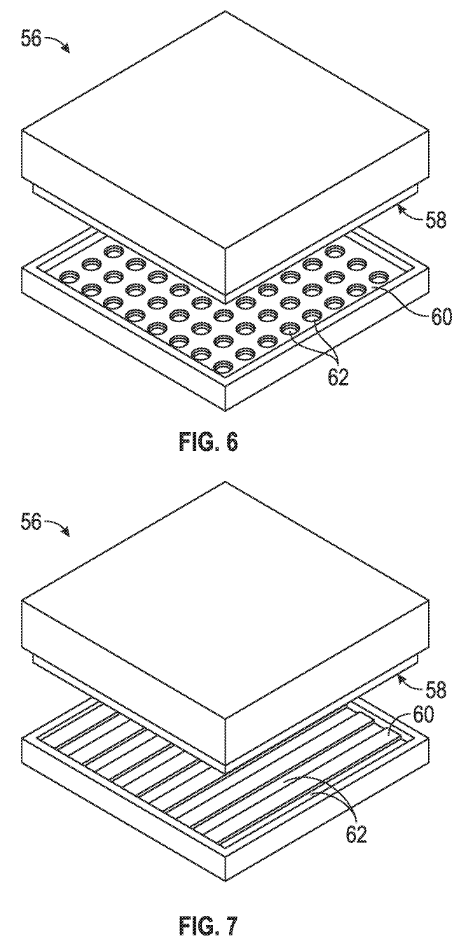

Block 104 depicts providing the slurry to a die 56, examples of which are illustrated in FIGS. 6 and 7. The slurry can be provided to the die 56 using a pump (not shown), for example.

Block 106 depicts compacting the slurry under high pressure with the die 56 to form a green compact. The titanium powder/slurry may be compacted into a desired shape using, for example, cold isostatic pressing. Cold isostatic pressing involves applying pressure uniformly from all directions resulting in a dense and uniform green compact or body. As shown in FIGS. 6 and 7, the die 56 includes a first surface 58 and a second surface 60. The first surface 58 of the die 56 is planar and the second surface 60 of the die 56 includes embossing features 62. The embossing features 62 are configured to form the embossed features 52 on the first porous transport layer (PTL) 42. The embossed features 52 may include the dimples (FIG. 6) and/or land channels (FIG. 7) as previously described.

Next, block 108 depicts sintering the green compact to form a titanium felt configured to subsequently function as the first porous transport layer (PTL) 42 in a membrane electrode assembly (MEA) 30. The titanium green compact is sintered at high temperatures in a controlled atmosphere (e.g., temperature, oxygen level, cooling time, and so forth), for example using a sintering furnace. Sintering involves heating the titanium green compact below its melting point to bond the particles together, enhancing mechanical strength and structural integrity.

Block 110 depicts cleaning the titanium felt to form a first porous transport layer (PTL). In some instances, cleaning the titanium felt may include minor cleaning or machining to remove undesired material.

Block 112 depicts coating the porous transport layer (PTL) with at least one of gold or platinum. The coating layer (i.e., the gold or platinum) can serve to reduce contact resistance and to reduce oxidation.

The membrane electrode assembly and membrane electrode assembly (MEA) 30 of the present disclosure is advantageous and beneficial over prior art. Because the separator plates in electrolyzers that are used in the flow field are formed from thin sheets of titanium, forming deep channels or dimples is challenging. The porous transport layer (PTL) of the membrane electrode assembly disclosed herein incorporates flow field features, for example dimples or land channels, which enable a reduction in pressure drop in the anode-side flow field and reduces a formability requirement of the anode-side separator plate.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An electrochemical cell, comprising:
a first electrode layer including an anode layer;
a second electrode layer including a cathode layer;
a polymer electrolyte membrane extending between the first electrode layer and the second electrode layer;
a first porous transport layer adjacent to the first electrode layer, wherein the first porous transport layer includes:
a first surface having a planar configuration, wherein the first surface faces the first electrode layer; and
a second surface including embossed features, wherein the second surface faces a first separator plate, and wherein the second surface is configured to facilitate water transport;
at least one of a second porous transport layer or a gas diffusion layer adjacent to the second electrode layer;
the first separator plate disposed adjacent to the first porous transport layer; and
a second separator plate disposed adjacent to the second porous transport layer.
.

2. The electrochemical cell of claim 1, wherein the embossed features include dimples.

3. The electrochemical cell of claim 1, wherein the embossed features include land channels.

4. The electrochemical cell of claim 1, wherein the first separator plate includes a side with embossed features including a dimple configuration facing the second surface of the first porous transport layer, wherein the embossed features of the second surface include dimples, and wherein the first separator plate and the second surface are disposed in a non-nested configuration that maximizes a water flow pathway.

5. The electrochemical cell of claim 1, wherein the first separator plate includes a side having embossed features including a dimple configuration facing the second surface of the first porous transport layer, wherein the embossed features of the second surface include land channels, and wherein the first separator plate and the second surface are disposed in a non-nested configuration that maximizes a water flow pathway.

6. The electrochemical cell of claim 1, wherein the first porous transport layer is at least one of porous titanium, nickel or stainless steel.

7. The electrochemical cell of claim 1, wherein the first porous transport layer includes a coating of titanium nitride.

8. The electrochemical cell of claim 1, wherein the first porous transport layer includes a coating of at least one of gold or platinum.

9. An electrolyzer having at least one electrochemical cell, comprising:
a membrane electrode assembly in the at least one electrochemical cell, the membrane electrode assembly including
a first electrode layer including an anode layer;
a second electrode layer including a cathode layer;
a polymer electrolyte membrane extending between the first electrode layer and the second electrode layer;
a first porous transport layer adjacent to the first electrode layer, wherein the first porous transport layer includes:
a first surface having a planar configuration, wherein the first surface faces the first electrode layer; and
a second surface including embossed features, wherein the second surface faces a first separator plate, and wherein the second surface is configured to facilitate water transport;
a second porous transport layer adjacent to the second electrode layer;
the first separator plate disposed adjacent to the first porous transport layer; and
a second separator plate disposed adjacent to the second porous transport layer.

10. The electrolyzer of claim 9, wherein the embossed features include dimples.

11. The electrolyzer of claim 9, wherein the embossed features include land channels.

12. The electrolyzer of claim 9, wherein the first separator plate includes a side with embossed features including a dimple configuration facing the second surface of the first porous transport layer, wherein the embossed features of the second surface include dimples, and wherein the first separator plate and the second surface are disposed in a non-nested configuration that maximizes a water flow pathway.

13. The electrolyzer of claim 9, wherein the first separator plate includes a side having embossed features including a dimple configuration facing the second surface of the first porous transport layer, wherein the embossed features of the second surface include land channels, and wherein the first separator plate and the second surface are disposed in a non-nested configuration that maximizes a water flow pathway.

14. The electrolyzer of claim 9, wherein the first porous transport layer is at least one of porous titanium, nickel, or stainless steel.

15. The electrolyzer of claim 9, wherein the first porous transport layer includes a coating of titanium nitride.

16. The electrolyzer of claim 9, wherein the first porous transport layer includes a coating of at least one of gold or platinum.

17. A process, comprising:
mixing titanium powder with adhesive powder and at least one lubricant to provide brittle titanium particles in a slurry;
providing the slurry to a die, wherein a first surface of the die is planar, and a second surface of the die includes embossing features configured to form embossed features on a porous transport layer;
compacting the slurry under high pressure with the die to form a green compact; and
sintering the green compact to form a titanium felt configured to function as a porous transport layer in a polymer electrolyte membrane electrolysis cell.

18. The process of claim 17, wherein the embossing features include at least one of dimples or land channels.

19. The process of claim 17, further comprising:
cleaning the titanium felt to form a porous transport layer.

20. The process of claim 17, further comprising:
coating the porous transport layer with at least one of gold or platinum.
